(19) United States
(12) Patent Application Publication
(10) Pub. No.: US 2013/0151089 A1
(43) Pub. Date: Jun. 13, 2013

(54) ENGINE TORQUE COMPENSATION METHOD BASED ON CHANGE IN CONCENTRATION OF ETHANOL FOR FFV

(71) Applicant: Soon Ki Kim, Gunpo-si (KR)

(72) Inventor: Soon Ki Kim, Gunpo-si (KR)

(73) Assignees: Kia Motors Corporation, Seoul (KR); Hyundai Motor Company, Seoul (KR)

(21) Appl. No.: 13/533,858

(22) Filed: Jun. 26, 2012

(30) Foreign Application Priority Data
Dec. 8, 2011 (KR) 10-2011-0130851

(51) Int. Cl. B60W 10/06; F02D 41/30; B60W 10/10; F02D 41/04

(52) U.S. Cl. 701/54; 701/102; 701/104

(57) ABSTRACT

An engine torque compensation method is based on a change in the concentration of ethanol for a Flexible Fuel Vehicle (FFV). In the method, a concentration of ethanol in fuel that is supplied to an engine is acquired. A driver-required torque based on an opening rate of a throttle valve depending on manipulation of an accelerator by a driver is calculated. A torque correction factor depending on the opening rate of the throttle valve and the concentration of the ethanol is calculated. A final driver-required torque is obtained by multiplying the torque correction factor by the driver-required torque.

### CROSS-REFERENCE TO RELATED APPLICATIONS

The present application claims priority of Korean Patent Application Number 10-2011-0130851 filed on Dec. 8, 2011, the entire contents of which application are incorporated herein for all purposes by this reference.

### BACKGROUND OF INVENTION

1. Field of Invention

The present invention relates, in general, to an engine torque compensation method based on a change in the concentration of ethanol of a Flexible Fuel Vehicle (FFV) and, more particularly, to technologies for properly compensating a variation in the torque of an engine that occurs as the concentration of ethanol changes in an FFV that uses the ethanol.

2. Description of Related Art

Due to the sudden world-wide increase in the price of crude oil, the demand for the relatively cheaper ethanol fuel compared to gasoline has suddenly increased in Brazil, China, Southeast Asia, the United States, etc. Technology for Flexible Fuel Vehicles (FFVs) that can use such ethanol fuel has been developed.

Ethanol used in FFVs has a theoretical air-fuel ratio of 9:1 and requires a larger quantity of fuel than does gasoline. In such a vehicle, the ethanol concentration of fuel is learned, detected or determined, and the quantity of fuel is corrected depending on the ethanol concentration, thus enabling an engine to be smoothly driven using a fuel mixture of ethanol and gasoline, or using only the fuel of 100% ethanol.

Fuel having different concentrations of ethanol may be injected into an FFV. Depending on the concentration of ethanol in the fuel, the heating value and octane value may change to a considerably higher degree, thus changing the knocking characteristics of the engine. Therefore, in the engine of the FFV, the output torque thereof changes depending on the concentration of ethanol in the supplied fuel. Such torque characteristics occur in the range of the total number of revolutions of the engine.

As described above, a variation in the torque characteristic of the engine depending on the concentration of the ethanol in fuel has a large influence on the power of the vehicle. Accordingly, when the output torque of the vehicle decreases due to the concentration of the ethanol in fuel, there is the high probability that the driving performance of the vehicle declines.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present application has been made keeping in mind the above problems occurring in the prior art, and various aspects of the present application to provide for an engine torque compensation method based on a change in concentration of ethanol for an FFV. The method can suitably compensate a variation in the torque of an engine that occurs as fuel having different concentrations of ethanol is supplied and then the concentration of ethanol in the fuel supplied to the engine of the FFV changes. Various aspects of the present invention provide for engine torque at a suitable level to have a stable driving, thus preventing users from potentially complaining about the driving performance, and improving the marketability of the FFV.

Various aspects of the present invention provide for an engine torque compensation method based on a change in a concentration of ethanol for a Flexible Fuel Vehicle (FFV). The method includes acquiring a concentration of ethanol in fuel that is supplied to an engine; b) calculating a driver-required torque based on an opening rate of a throttle valve depending on manipulation of an accelerator by a driver; c) calculating a torque correction factor based on the opening rate of the throttle valve and the concentration of the ethanol; and d) obtaining a final driver-required torque by multiplying the torque correction factor calculated in c) by the driver-required torque calculated in b).

Various aspects of the present invention provide for an engine torque compensation method based on a change in a concentration of ethanol for a Flexible Fuel Vehicle (FFV). The method includes learning a concentration of ethanol if an oxygen sensor is normal; receiving an opening rate of a throttle valve based on manipulation by a driver; calculating a driver-required torque in consideration of the opening rate of the throttle valve; obtaining a torque correction factor based on both the received opening rate of the throttle valve and the learned concentration of the ethanol; and obtaining a final driver-required torque by multiplying the torque correction factor by the calculated driver-required torque.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart showing an exemplary engine torque compensation method based on a change in the concentration of ethanol for an FFV according to the present application.

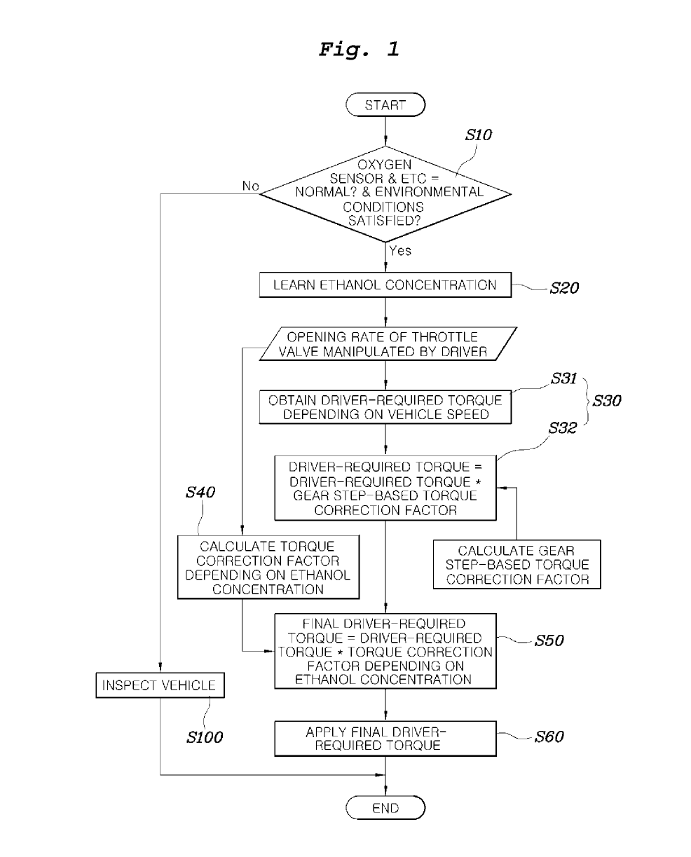

FIG. 2 is a diagram showing a map of torque correction factors depending on the opening rates of a throttle valve and the concentrations of ethanol, the map being used in the engine torque compensation method according to the present application.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims

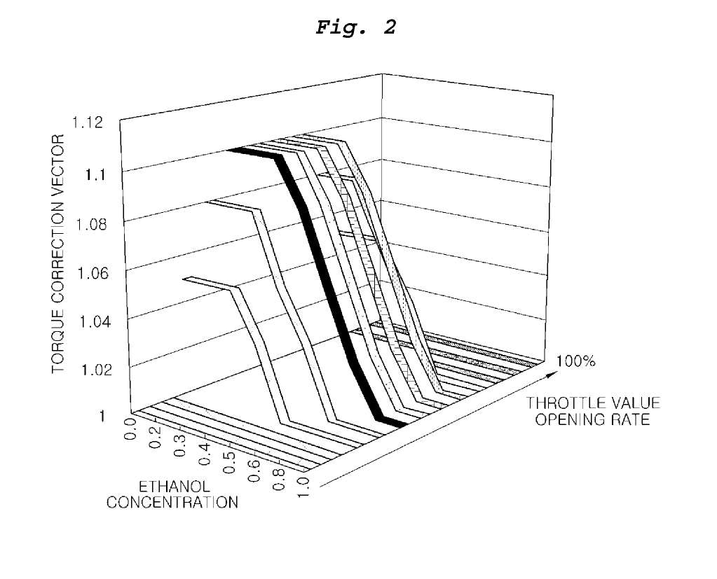

Referring to FIG. 2, various embodiments of an engine torque compensation method based on a change in the concentration of ethanol for an FFV according to the present application include a concentration acquisition step S20, a required torque calculation step S30, a concentration correction factor calculation step S40, and a required torque fixing step S50. In step S20, the concentration of ethanol in fuel that is supplied to an engine is acquired. In step S30, the torque required by a driver (driver-required torque) is calculated based on the opening rate of a throttle valve depending on the manipulation of an accelerator by the driver. In step S40, a torque correction factor is calculated depending on the opening rate of the throttle valve and the concentration of the ethanol. In step S50, a final driver-required torque is obtained by multiplying the torque correction factor calculated in the concentration correction factor calculation step S40 by the driver-required torque calculated in the required torque calculation step S30.

That is, the concentration of the ethanol contained in fuel that is substantially supplied to the engine is acquired, so that the torque correction factor is obtained in consideration of both the opening rate of the throttle valve by the driver and the concentration of the ethanol. Accordingly, the driver-required torque that is basically calculated based on the opening rate of the throttle valve is corrected by means of the torque correction factor, thus preventing the torque of the engine from varying depending on the change in the concentration of the ethanol in the fuel.

In other words, the engine is controlled using the driver-required torque in which the variation in the torque of the engine caused by the increase/decrease in the concentration of ethanol in the fuel is compensated for using the torque correction factor. Ultimately, the output of the engine can be kept in a stable state, without being increased or decreased by the concentration of the ethanol, so that the driver can feel that the driving performance of the vehicle is stable. Further, the occurrence of complaints about the phenomenon of decreasing power or the like as in the case of the prior art is prevented, so that the marketability of the vehicle can be improved.

In various embodiments, before the concentration acquisition step S20, the condition determination step S10 of determining whether an oxygen sensor is normal or abnormal and also determining whether an Electronic Throttle Control (ETC) is normal or abnormal may be performed. In this case, in various embodiments, the method of the present application is configured such that the concentration acquisition step S20 is performed only when both the oxygen sensor and the ETC are normal. In the concentration acquisition step S20, the concentration of the ethanol in the fuel is learned, calculated or determined using a correction value for the quantity of fuel injected which has been fed back by the oxygen sensor.

That is, in the concentration acquisition step S20, the concentration of the ethanol in the fuel is estimated and learned using the output value of the oxygen sensor, so that the concentration of the ethanol is detected. Accordingly, it is determined whether the oxygen sensor is normal before performing the concentration acquisition step S20.

Further, the reason for determining whether the ETC is normal in the condition determination step S10 is that the ETC should be normal so that torque control can take place normally based on the driver-required torque, and thus the normality of the ETC should be checked in advance.

Of course, if at least one of the oxygen sensor and the ETC is not normal, it is meaningless to further perform control according to various embodiments of the present application, and thus it may prompt the user to inspect the vehicle in step S100 by providing a warning to that effect, and terminate the control according to various embodiments of the present application.

Further, in various embodiments, as shown in the condition determination step S10, the environmental conditions required for the performance of the present application are determined. In detail, it is determined whether the number of revolutions of the engine is in a steady state, whether a Mass Air Flow (MAF) sensor is normal, and whether the atmospheric pressure condition is normal. Accordingly, if all of these conditions have been satisfied, it is possible to maintain the torque of the engine substantially at a constant level using the present application, and thus the process may proceed to the subsequent steps.

In the required torque calculation step S30, a vehicle speed consideration sub-step S31 is performed in which a driver-required torque is calculated depending on the opening rate of the throttle valve based on the manipulation of the driver and the current speed of the vehicle. After the vehicle speed consideration sub-step S31, a gear step consideration sub-step S32 is performed in which a new driver-required torque is calculated by multiplying a gear step-based torque correction factor corresponding to the current gear step of a gearshift by the driver-required torque obtained in the vehicle speed consideration sub-step S31.

That is, before the final driver-required torque is determined using the torque correction factor calculated in the concentration correction factor calculation step S40, the vehicle speed consideration sub-step S31 and the gear step consideration sub-step S32 are performed. Then, the torque correction factor calculated in the concentration correction factor calculation step S40 is applied to the driver-required torque determined by performing the steps S31 and S32. Therefore, the final driver-required torque may be a value in which all of the vehicle speed, the current gear step of the gearshift, and the concentration of the ethanol are taken into consideration on the basis of the opening rate of the throttle valve manipulated by the driver.

In the concentration correction factor calculation step S40, the torque correction factor is calculated using a previously constructed map, that is, a map of torque correction factors depending on the opening rates of the throttle valve and ethanol concentrations, as shown in FIG. 2.

That is, the torque correction factor depending on the current opening rate of the throttle valve and the current ethanol concentration is calculated from the map of FIG. 2, which has been previously constructed and stored and which defines the relationships among the opening rates of the throttle valve, the ethanol concentrations, and the torque correction factors.

Of course, the map constructed as shown in FIG. 2 is suitably implemented through a plurality of experiments and in conformity with design intentions.

After the required torque fixing step S50, a required torque application step S60 is performed which applies the final driver-required torque to the engine and then controls the engine. That is, the quantity of fuel to be injected into the engine, the ignition time of the engine, etc. are controlled in consideration of the final driver-required torque, thus enabling the engine to generate a torque that is always at a suitable level regardless of the concentration of the ethanol in the fuel.

As described above, the present application can suitably compensate for a variation in the torque of an engine that occurs as fuel having different concentrations of ethanol is supplied and then the concentration of ethanol in the fuel supplied to the engine of the FFV changes, so that the engine torque that is always at a suitable level can be formed to allow the driving performance of the vehicle to be stable, thus preventing users from potentially complaining about the driving performance, and improving the marketability of the FFV.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine torque compensation method based on a change in a concentration of ethanol for a Flexible Fuel Vehicle (FFV), comprising:
a) acquiring a concentration of ethanol in fuel that is supplied to an engine;
b) calculating a driver-required torque based on an opening rate of a throttle valve depending on manipulation of an accelerator by a driver;
c) calculating a torque correction factor based on the opening rate of the throttle valve and the concentration of the ethanol; and
d) obtaining a final driver-required torque by multiplying the torque correction factor calculated in c) by the driver-required torque calculated in b).

2. The engine torque compensation method according to claim 1, further comprising, before a), e) determining whether an oxygen sensor is normal and whether an Electronic Throttle Control (ETC) is normal,
wherein a) is performed if it is determined that both the oxygen sensor and the ETC are normal.

3. The engine torque compensation method according to claim 2, wherein a) is configured such that the concentration of the ethanol in the fuel is learned using a correction value for a quantity of fuel injected, which has been fed back by the oxygen sensor.

4. The engine torque compensation method according to claim 1, wherein b) comprises:
b1) calculating the driver-required torque based on the opening rate of the throttle valve depending on manipulation of the driver and a current speed of the vehicle.

5. The engine torque compensation method according to claim 4, wherein b) further comprises, after b1):
b2) calculating a new driver-required torque by multiplying a gear step-based torque correction factor corresponding to a current gear step of a gearshift by the driver-required torque calculated in b1).

6. The engine torque compensation method according to claim 1, wherein:
in c), the torque correction factor is calculated using a previously constructed map of torque correction factors correlated with opening rates of the throttle valve and ethanol concentrations; and
the method further comprises, after d), f) controlling the engine by applying the final driver-required torque to the engine.

7. An engine torque compensation method based on a change in a concentration of ethanol for a Flexible Fuel Vehicle (FFV), comprising:
learning a concentration of ethanol if an oxygen sensor is normal;
receiving an opening rate of a throttle valve based on manipulation by a driver;
calculating a driver-required torque in consideration of the opening rate of the throttle valve;
obtaining a torque correction factor based on both the received opening rate of the throttle valve and the learned concentration of the ethanol; and
obtaining a final driver-required torque by multiplying the torque correction factor by the calculated driver-required torque.

8. The engine torque compensation method according to claim 7, wherein the calculating the driver-required torque in consideration of the opening rate of the throttle valve is configured to calculate the driver-required torque based on the opening rate of the throttle valve and a current speed of a vehicle, and to update the driver-required torque to a new driver-required torque by multiplying a torque correction factor based on each gear step of a gearshift by the driver-required torque.

9. The engine torque compensation method according to claim 7, further comprising, after the obtaining the final driver-required torque, applying the obtained final driver-required torque to control of the engine,
wherein if it is determined that the oxygen sensor is not normal, the control is terminated while a warning prompting the vehicle to be inspected is provided without learning ethanol.

10. The engine torque compensation method according to claim 7, wherein the obtaining the torque correction factor based on both the opening rate of the throttle valve and the learned concentration of ethanol is configured to calculate the torque correction factor based on a current opening rate of the throttle valve and a current concentration of the ethanol from a previously constructed map, which defines relationships among opening rates of the throttle valve, ethanol concentrations, and torque correction factors.
